(19) United States
(12) Patent Application Publication
(10) Pub. No.: US 2006/0281620 A1
(43) Pub. Date: Dec. 14, 2006

(54) Sheet processing apparatus and image forming apparatus

(75) Inventors: Kenichi Hayashi, Abiko-shi (JP); Toshimasa Suzuki, Kashiwa-shi (JP); Atsuteru Oikawa, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Ohta-ku (JP)

(21) Appl. No.: 11/447,815

(22) Filed: Jun. 6, 2006

(30) Foreign Application Priority Data
Jun. 10, 2005 (JP) 2005-171718

(51) Int. Cl. B31B 1/26

(52) U.S. Cl. 493/405

(57) ABSTRACT

A sheet processing apparatus including a folding unit, a crease processing unit, and a holding portion. The folding unit is configured to fold a sheet bundle, the crease processing unit forms a crease on a folded part of the sheet bundle, and the holding portion holds the sheet bundle between the folding unit and the crease processing unit as the crease processing unit forms the crease on the folded part.

### BACKGROUND OF THE INVENTION

1. Field of the Invention

The present invention relates to a sheet processing apparatus, which folds down a sheet bundle to make a booklet and more particularly, relates to a sheet processing apparatus that prevents misalignment of a sheet bundle when a crease is formed in the folded part of the sheet bundle, and an image forming apparatus provided with this sheet processing apparatus at its main body.

2. Description of the Related Art

Conventionally, the main body of the image forming apparatus for forming an image on a sheet may be provided with a sheet processing apparatus for making the sheet on which the image is formed by the main body of the image forming apparatus into a bundle and folding down the bundle to take a booklet form behaving as a component portion. For example, this sheet processing device sequentially receives the sheets having the image formed thereon by means of a stacking tray, aligns them, stitches near the center thereof, pushes this center into a nip of a folding roller pair, folds down the sheet bundle, and conveying the bundle by the folding roller pair to bring it into a booklet (refer to JP-A-2003-182928).

The sheet processing apparatus disclosed in JP-A-2003-182928, namely, the one as shown in FIG. 20 certainly forms a crease on the folded part in such a manner that a second folding roller 85 presses a folded part Pa of a sheet bundle P that is folded by first folding roller pairs 83, 84 to move the folded part Pa along a crease.

Nevertheless, in order to ensure the formation of a crease on the folded part of the sheet bundle, the conventional sheet processing apparatus must operate in a manner such that the second folding roller 85 runs on a side end portion of the sheet bundle held by only the first folding roller pair 83, 84. Therefore, the position of the sheet bundle may be misaligned due to generation of torque centering about the first folding roller pair 83, 84, respectively, on the sheet bundle.

As a result, the second folding roller 85 drives on the crease while misaligning the position of the sheet bundle, and this involves a problem such that the crease cannot be surely formed on the folded part. In addition, due to misalignment of the position, a wrinkle appears on the sheet bundle, the trail of the roller is applied on the sheet bundle, and the sheet bundle is torn so as to damage the folded part. At worst, there is a probability that the second folding roller 85 cannot be driven. These phenomena more readily occur as the thickness of the sheet bundle is increased.

Further, according to the image forming apparatus including such a sheet processing apparatus, it is necessary to form the image on a sheet or sheets again by an amount of the damaged sheets, so that the image forming efficiency is reduced.

### SUMMARY OF THE INVENTION

The present invention is directed to a sheet processing apparatus which improves the accuracy of processing a crease of a folded part by preventing a position of a sheet bundle from being misaligned when forming the crease on the folded part of the sheet bundle.

The present invention is also directed to an image forming apparatus by which the efficiency of the image formation can be increased due to provision of the sheet processing apparatus of which the processing accuracy of the crease on the folded part is enhanced.

According to one aspect of the present invention, a sheet processing apparatus includes a folding unit configured to fold a sheet bundle; a crease processing unit forming a crease on the folded part of the sheet bundle; and a holding portion holding the sheet bundle between the folding unit and the crease processing unit, as the crease processing unit forms the crease on the folded part of the sheet bundle.

According to another aspect of the present invention, a sheet processing apparatus includes a folding unit configured to hold and fold a sheet bundle while conveying the sheet bundle; a crease processing unit forming a crease on the folded part of the sheet bundle; and a holding portion holding the sheet bundle between the folding unit and the crease processing unit, wherein the folding unit and the holding portion hold the sheet bundle when the crease processing unit is forming the crease on the folded part of the sheet bundle.

In order to yet another aspect of the present invention, an image forming apparatus includes an image forming portion configured to form an image on a sheet; and the sheet processing apparatus, which carries out a crease processing on a folded part of a sheet bundle on which the image is formed by the image forming portion, as described above.

According to the sheet processing apparatus according to the present invention, when the crease processing unit forms a crease on the folded part, the sheet bundle is held by the holding portion between the folding unit and the crease processing unit, so that misalignment of the sheet bundle can be prevented by reducing generation of any rotation moment against the sheet bundle. Therefore, the sheet processing apparatus according to the present invention can certainly form a crease on the folded part of the sheet bundle without damaging the folded part of the sheet bundle, and this leads to an increase in the processing accuracy of the crease on the folded part.

According to the sheet processing apparatus according to the present invention, when the crease processing unit forms a crease on the folded part, the sheet bundle is held by the folding unit and the holding portion, so that misalignment of the sheet bundle can be prevented by reducing generation of torque applied to the sheet bundle. Therefore, the sheet processing apparatus according to the present invention can surely form a crease on the folded part of the sheet bundle without damaging the folded part of the sheet bundle, and this leads to an improvement in the accuracy of processing of the crease on the folded part.

Since the image forming apparatus includes the sheet processing apparatus, which improves the accuracy of processing of the crease on the folded part without damaging the folded part of the sheet bundle, any need for re-conducting formation of the image on the sheet can be eliminated and this makes it possible to increase the image formation efficiency of the image forming apparatus.

Further features of the present invention will become apparent from the following description of exemplary embodiments (with reference to the attached drawings).

### BRIEF DESCRIPTION OF THE DRAWINGS

FIG. 1 is a cross-sectional view taken along a sheet feeding direction of a finisher having a saddle stitch binding portion as a sheet processing apparatus according to an embodiment of the present invention;

FIG. 2 is a cross-sectional view taken along a sheet feeding direction of a copy machine as an image forming apparatus according to the embodiment of the present invention;

FIG. 3 is a perspective outline view of the saddle stitch binding portion as the sheet processing apparatus according to the embodiment of the present invention;

FIG. 4 is a front view of a crease pressing unit of the saddle stitch binding portion shown in FIG. 3;

FIG. 5 is a diagrammatic view of the crease pressing unit of the saddle stitch binding portion shown in FIG. 3, when viewing from an arrow A in FIG. 1;

FIG. 6 is diagrammatic view of the crease pressing unit of the saddle stitch binding portion shown in FIG. 3, when viewing from an arrow C in FIG. 1;

FIG. 7 is an outline perspective view of a press holder portion of the crease pressing unit;

FIG. 8 is a front view of the press holder portion of the crease pressing unit;

FIG. 9 is a diagrammatic view of the crease pressing unit of the saddle stitch binding portion shown in FIG. 3, when viewing from an arrow B in FIG. 1;

FIG. 10 is a diagrammatic view taken from an arrow X-X in FIG. 8;

FIG. 11 is a control block diagram of the entire copy machine;

FIG. 12 a diagrammatic view illustrating a state where a sheet bundle is stored in a storage guide of the saddle stitch binding portion to be stitched;

FIG. 13 a diagrammatic view illustrating a state where the folding of a stitched position of the sheet bundle stored in the storage guide of the saddle stitch binding portion begins;

FIG. 14 is a schematic view illustrating a state where the saddle stitch binding portion starts to fold the sheet bundle;

FIG. 15 a diagrammatic view illustrating a state where the saddle stitch binding portion feeds a folded sheet bundle to a press roller pair;

FIG. 16 a diagrammatic view illustrating a state where the press roller pair of the saddle stitch binding portion starts the operation for certainly forming a crease on the folded part of the folded sheet bundle;

FIG. 17 a diagrammatic view illustrating a state where the press roller pair of the saddle stitch binding portion has started the operation for surely forming a crease on the folded part of the folded sheet bundle;

FIG. 18 a diagrammatic view illustrating a state where the press roller pair of the saddle stitch binding portion has completed press of the folded part of the folded sheet bundle;

FIG. 19 shows a diagrammatic view illustrating a state where a bundle of stitch bound sheets is discharged by the saddle stitch binding portion;

FIG. 20 is a schematic view illustrating the operation of a conventional sheet processing apparatus.

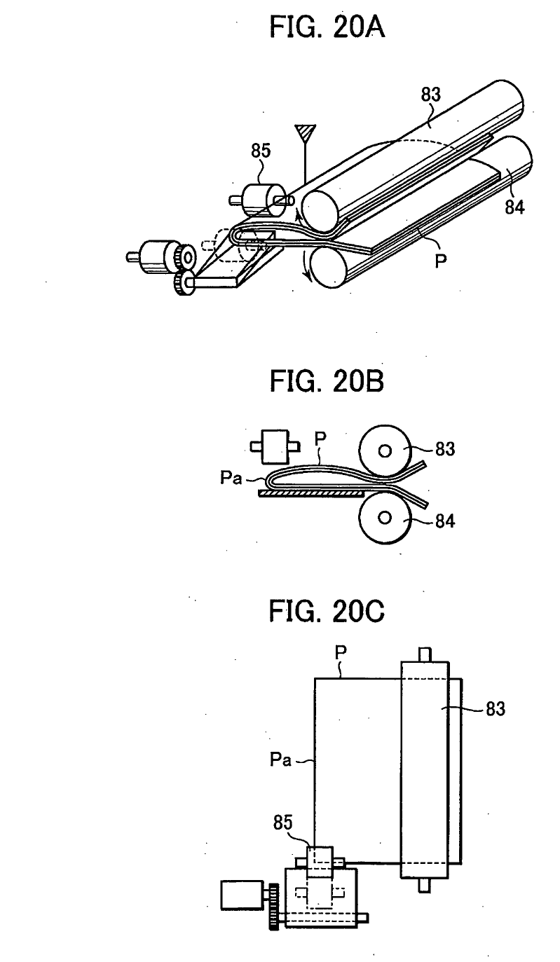

### DESCRIPTION OF THE EMBODIMENTS

Hereinbelow, a description of a finisher including a saddle stitch binding portion 800 as a sheet processing apparatus according to an embodiment of the present invention and an image forming apparatus including this finisher will be provided with reference to the drawings.

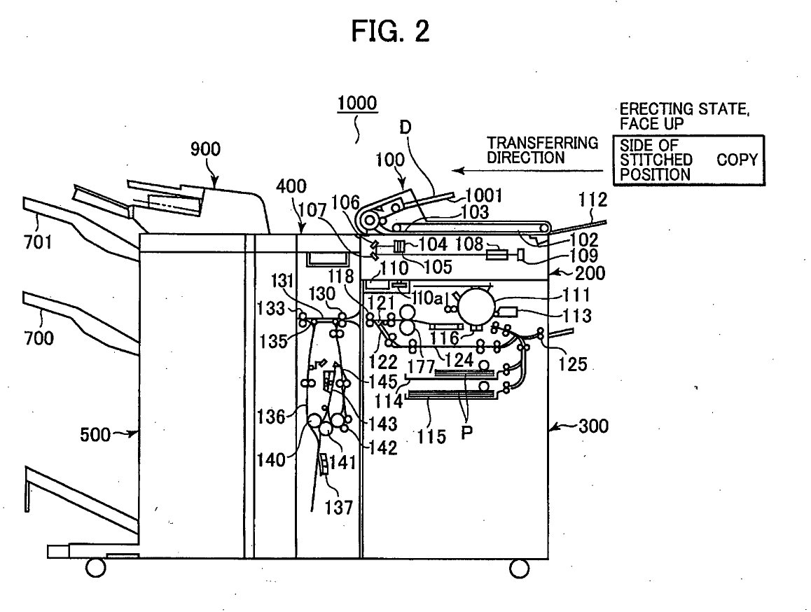

FIG. 2 is a cross-sectional view taken along the sheet feeding direction of a copy machine as the image forming apparatus according to the embodiment of the present invention.

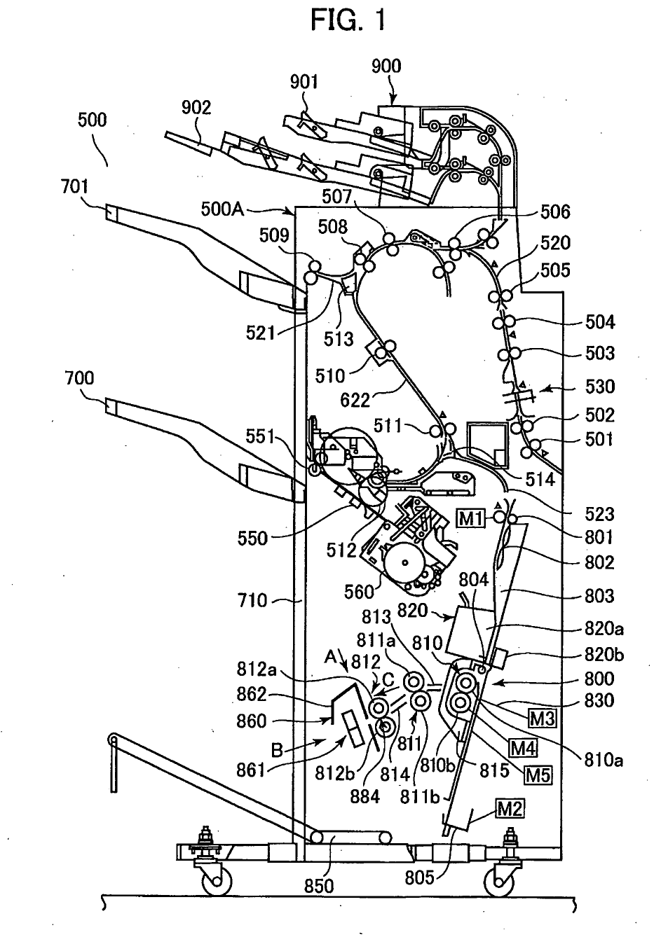

A copy machine 1000 serving as an image forming apparatus is provided with a copy feeding portion 100, an image reader portion 200, a printer portion 300, a folding process portion 400, a finisher 500, a saddle stitch binding portion 800 (refer to FIG. 1), an inserter 900, and so on. The folding process portion 400 and the inserter 900 or the like can be mounted as an option.

On a tray 1001 of the copy feeding portion 100, a copy is to be set face up (the state that the face on which the image is formed is directed upward). The stitched position of the copy is defined as a left end portion of the copy. The copy set on the tray 1001 is fed in a left direction, namely, with the stitched position being a front end for each copy by rotation from a head page from the copy feeding portion 100. Then, the copy passes through a curved path to be fed from a left direction to a right direction on a platen glass 102, and then, it is discharged to a catch tray 112. In this case, a scanner unit 104 stops at a predetermined copy reading position.

The scanner unit 104 reads the image of the copy passing on the scanner unit 104 from left to right. Such a method of reading a copy is called “skimming”. When the copy passes on the platen glass 102, the copy is irradiated by a lamp 103 of the scanner unit 104. The reflection light from this copy is introduced to an image sensor 109 via mirrors 105, 106, 107, and a lens 108.

Further, the image reader portion 200 temporarily stops the copy on the platen glass 102 by the copy feeding portion 100. The image reader portion 200 also can read the copy moving the scanner unit 104 as it is from left to right. This reading method is called “scanned reading”. In the case of reading the copy without using the copy feeding portion 100, a user opens and closes the copy feeding portion 100 to set the copy on the platen glass 102. Thereafter, the scanner unit 104 carries out the fixed reading.

The image data of the copy read by the image sensor 109 is transmitted to an exposure control portion 110 after being subjected to a given predetermined image processing. The exposure control portion 110 outputs a laser beam depending on an image signal. The laser beam is irradiated on a photoconductive drum 111 while being scanned by a polygon mirror 110a. Then, an electrostatic latent image depending on the scanned laser beam is formed on the photoconductive drum 111.

The electrostatic latent image formed on the photoconductive drum 111 is developed by a development device 113 so as to be visualized as a toner image. On the other hand, a sheet (recording paper) P is fed from any one of cassettes 114, 115, a manual paper feeding portion 125, and a both-side conveying portion 124 to a transfer portion 116. Then, the visualized toner image is transcribed on the sheet at the transfer portion 116. The toner image of the transferred sheet is fixed at a fixing portion 177. The photoconductive drum 111 and the development device 113 or the like constitute an image forming portion.

The sheet passing through the fixing portion 177 is once guided by a flapper 121 to be forwarded to a path 122. As soon as the rear end of the sheet runs through the flapper 121, the sheet is conveyed by switchback to be guided by the flapper 121 to an ejection roller 118. The sheet is ejected from a printer portion 300 by the ejection roller 118. Thereby, the sheet is ejected from the printer portion 300 with the surface having the toner image formed face down. These operations are referred to as “reverse paper ejection”.

When the sheet is ejected face down toward the exterior of the copy machine, it is possible to carry out the image forming processing by rotation from the head page. For example, in the case of carrying out the image forming processing by using the copy feeding portion 100 and in the case of carrying out the image forming processing with respect to the image data coming from a computer, it is possible to arrange the order of the pages.

In addition, when forming the image on both sides of the sheet, the printer portion 300 guides the sheet from the fixing portion 177 directly to the ejection roller 118. As soon as the rear end of the sheet runs through the flapper 121, the sheet is conveyed by switchback and is guided to the both-side conveying portion 124 by the flapper 121.

Next, the structures of the folding process portion 400 and the finisher 500 will be described with reference to FIGS. 1 and 2. FIG. 1 is a cross-sectional view taken along a sheet feeding direction of a finisher.

In FIG. 2, the folding process portion 400 includes a conveying path 131 for receiving the sheet ejected from the printer portion 300 and for guiding it to the finisher 500. The conveying path 131 is provided with a conveying roller pair 130, 133. Further, a switching flapper 135 provided near the conveying roller pair 133 guides the sheet conveyed by the conveying roller pair 130 to a folding path 136 or the finisher 500.

In the case of carrying out the folding process of the sheet, the switching flapper 135 guides the sheet to the folding path 136 being switched to the side of the folding path 136. The sheet guided to the folding path 136 is conveyed to folding rollers 140 and 141 to be folded down into a Z-shape.

When the folding process is not carried out, the switching flapper 135 is switched to the side to guide the sheet to the finisher 500. Then, the sheet ejected from the printer portion 300 passes through the conveying path 131 and the switching flapper 135 to be directly fed to the finisher 500.

The sheet conveyed to the folding path 136 is folded down by the folding rollers 140 and 141 after a loop is formed with its front end abutted against a stopper 137. By further folding down the loop formed by abutting this folded part against an upper stopper 143, the sheet is folded down in the Z-shape. The sheet folded down in the Z-shape is guided to conveying paths 145 and 131 to be discharged to the finisher 500 by the conveying roller 133. Further, the folding process operation due to the folding process portion 400 is selectively performed.

The finisher 500 serves to carry out the processing of the sheet, for example, the processing to form a sheet bundle by aligning the plural sheets conveyed from the printer portion 300 via the folding process portion 400; the staple processing (the stitching processing) to staple the rear end side of the sheet bundle; the sort processing; and the non-sort processing or the like.

As shown in FIG. 1, the finisher 500 has a conveying path 520 for taking the sheet conveyed via the folding process portion 400 into the inside of the copy machine. The conveying path 520 is provided with conveying roller pairs 502 to 508 by rotation from an inlet roller pair 501 toward a downstream side of a direction of conveying of the sheet.

A punch unit 530 is disposed between the conveying roller 502 and the conveying roller 503. The punch unit 530 serves to bore or perforate a hole (perform the boring operation) at the rear end portion of the sheet to be fed by carrying out the operation as required.

A flapper 513 disposed at the terminal end of a conveying path 520 serves to selectively switch the path between an upper paper ejection path 521 and a lower paper ejection path 622 that are fastened to the downstream side thereof. The upper paper ejection path 521 ejects the paper to an upper stack tray by an upper paper ejection roller 509. On the other hand, the lower paper ejection path 622 is provided with conveying roller pairs 510, 511, and 512 so as to convey the sheet to a processing tray 550 by these conveying roller pairs and eject it.

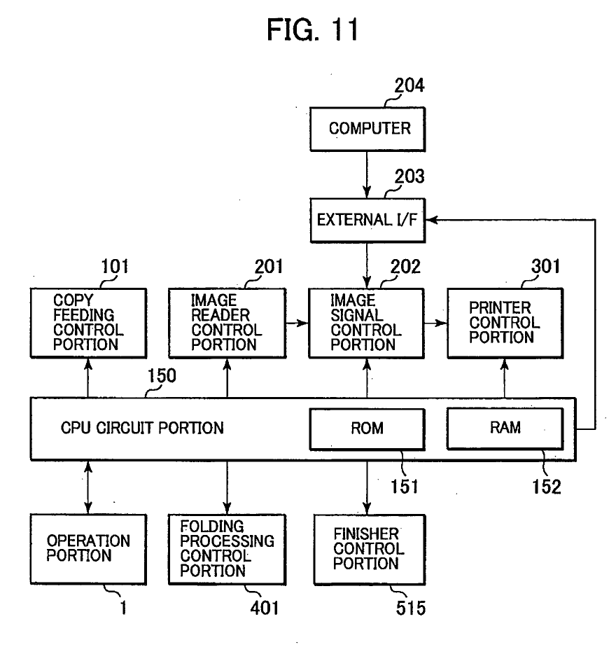

The sheets ejected to the processing tray 550 are stacked into a bundle being aligned sequentially, and the sort processing and the staple processing are carried out depending on the setting due to an operation portion 1 (FIG. 11). Then, the sheet is selectively ejected to a stack tray 700 and a sample tray 701 by a bundle ejection roller pair 551.

Further, the staple processing is carried out by a stapler 560. The stapler 560 staples the arbitrary part of the sheet bundle in a width direction of the sheet bundle (namely, a direction intersecting with the sheet conveying direction). The stack tray 700 and the sample tray 701 move up and down along a main body 500A of the stapler 500. The upper sample tray 701 receives the sheet from the upper paper ejection path 521 and the processing tray 550. In addition, the lower stack tray 700 serves to receive the sheet from the processing tray 550. Thus, large amounts of sheets are stacked on the stack tray 700 and the sample tray 701. The stacked sheets are aligned with rear ends thereof received by a rear end guide 710 elongated vertically.

Next, a description of the configuration of the saddle stitch binding portion 800 will be provided hereinbelow.

A switching flapper 514 disposed in the middle of the lower paper ejection path 622 switches the sheet into the right side to guide the sheet to a saddle paper ejection path 523 and to the saddle stitch binding portion 800. From the inlet of the saddle stitch binding portion 800, a saddle inlet roller pair 801, a flapper 802 operated by a solenoid depending on the size, a storage guide 803 storing the sheet therein, a slip roller 804, and a sheet positioning member 805 are disposed by rotation.

The saddle inlet roller pair 801 and the slip roller 804 are rotated by a motor M1. In addition, in the middle of the storage guide 803, a stapler 820 is arranged in an opposed manner while sandwiching the storage guide 803. That is to say, the stapler 820 is provided with a driver 820a extruding a needle and an anvil 820b to fold down the extruded needle.

The sheet positioning member 805 receives the front end (the lower end) of the sheet upon carrying-in of the sheet, and the sheet positioning member can rise and fall to adjust the position of the sheet so that the center part of a direction of conveying of the sheet is located at the stapling position of the stapler 820. The sheet positioning member 805 rises and falls by a motor M2 so as to stop at a position depending on the size of the sheet.

At the downstream side of the stapler 820, folding roller pairs 810a and 810b are disposed. At the opposed positions of the folding roller pairs 810a and 810b, an extrusion member 830 is provided. The folding roller pairs 810a and 810b and the extrusion member 830 constitute the folding unit.

This extrusion member 830 is extruded from a motor M3 toward the stored sheet bundle with a position left from the storage guide 803 as its home position so as to press the sheet bundle into nips of the folding roller pair 810a and 810b. After that, the extrusion member 830 will return to the home position again. The enough pressure F1 to fold down the sheet bundle is added between the folding roller pair 810 by a spring (not illustrated).

The sheet bundle folded down by the folding roller pair 810 is discharged into a folded bundle stacking tray 850 via a first folding conveying roller pair 811a and 811b, and a second folding conveying roller pair 812a and 812b.

The sufficient forces F2 and F3 to convey and stop the folded sheet bundle are added between the first folding conveying roller pair 811 and between the second folding conveying roller pair 812.

A conveying guide 813 guides the sheet bundle between the folding roller pair 810 and the first folding conveying roller pair 811. A conveying guide 814 guides the sheet bundle between the first folding conveying roller pair 811 and the second folding conveying roller pair 812. Further, the folding roller pair 810, the first folding conveying roller pair 811, and the second folding conveying roller pair 812 sandwich the internally folded sheet bundle from both sides so as to be rotated at the constant speed by the same motor M4 (not illustrated).

A aligning plate pair 815 has a face protruded to the storage guide 803 rotating around the external circumferential face of the folding roller pair 810a and 810b so as to conduct alignment of the width of the sheets that are stored in the storage guide 803. The aligning plate pair 815 moves in a direction of sandwiching the sheet by a motor M5 and performs the positioning in a direction of the width of the sheet.

At the downstream side of the second folding conveying roller pair 812, a crease pressing unit 860 is disposed. This crease pressing unit 860 has a press holder 862 supporting a press roller pair 861, and the crease pressing unit enhances the crease by moving the press holder 862 in a direction of the crease with the crease nipped by the press roller pair 861. In other words, the crease is certainly made. Just below the crease pressing unit 860, the folded bundle stacking tray 850 is disposed.

Next, a description of the structure of the crease pressing unit 860 will be provided hereinbelow.

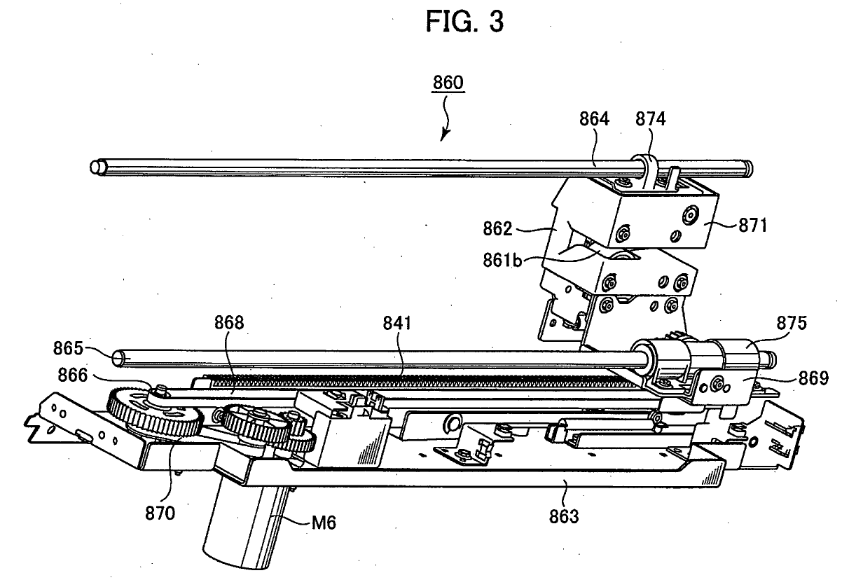

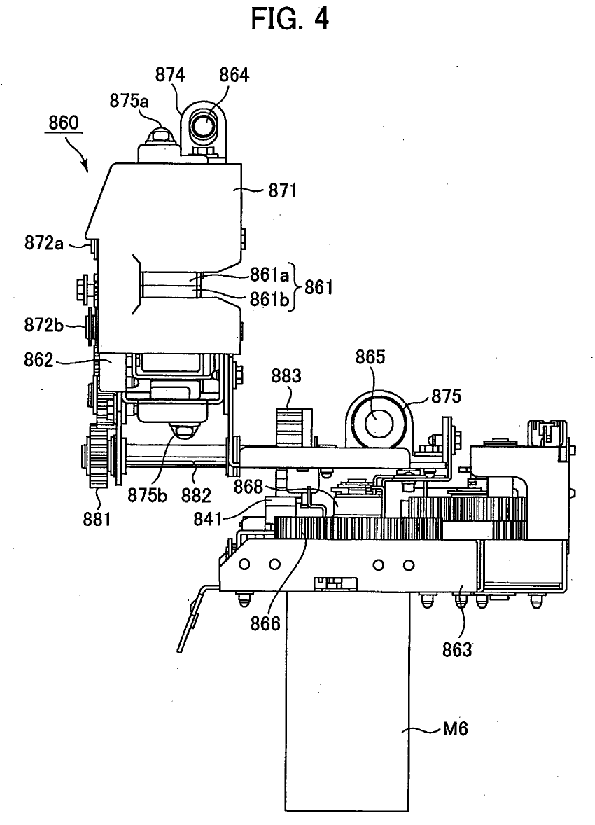

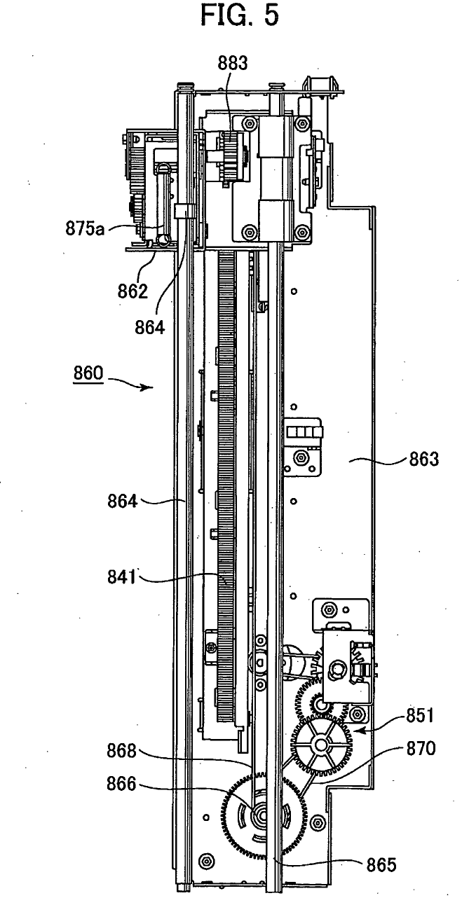

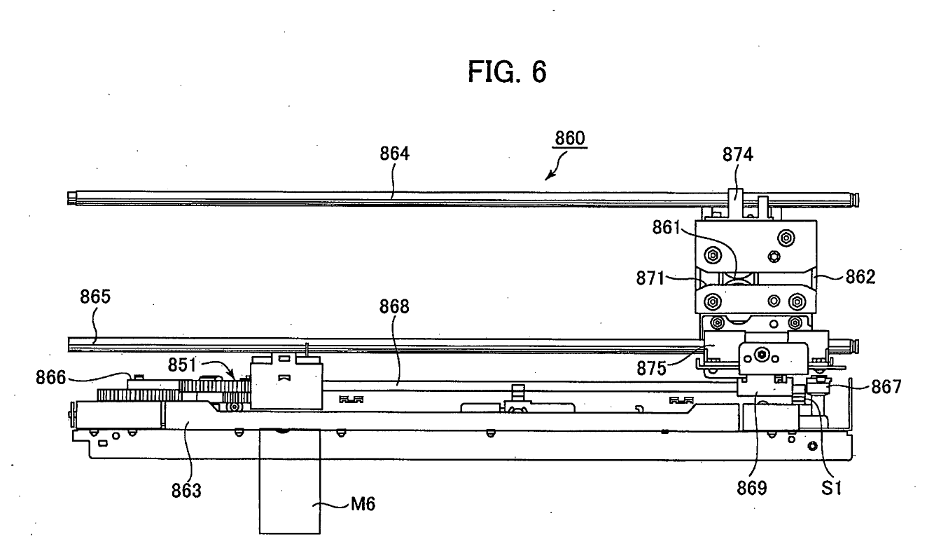

FIG. 3 is a perspective view of the crease pressing unit, FIG. 4 is a front view of the crease pressing unit, FIG. 5 is a view along arrow A in FIG. 1, and FIG. 6 is a view along arrow C in FIG. 1, respectively.

The crease pressing unit 860 has a base plate 863 incorporating the major portions therein and two slide shafts 864, 865 to be fixed at the front and rear side plates of a main body 500A of the finisher. The two slide shafts 864, 865 are arranged in parallel and elongated in front and back directions of the finisher 500 (FIG. 1) to support a press holder 862 via slide bearings 874 and 875 fixed on the press holder 862, respectively.

A timing belt 868 is mounted and wound around pulleys 866 and 867 (FIG. 6) that are rotatably arranged at ends of the base plate 863. A part of the timing belt 868 is fixed to the press holder 862 by an interlinked plate 869. On the pulley 866, a belt 870 (FIG. 5) is mounted and coupled to a motor M6 attached on the base plate 863 through a gear row 851 for transmitting the drive. Accordingly, the press holder 862 moves in back and forth (front and back) directions (direction of the width of the sheet) of the finisher 500 in association with the rotation of the motor M6.

The home position of the press holder 862 is arranged on the back side of the finisher 500. This position is detected by a home sensor S1 (FIG. 6). When the press holder 862 is located at the home position, it is possible to discharge the sheet bundle to the folded bundle stacking tray 850 by means of the second folding conveying roller pair 812.

The press holder 862 will be described. Further, on the press holder 862, a sheet guide 871 (FIGS. 3, 4, and 6) is attached against the press roller pair 861. However, in some of the drawings, the sheet guide 871 is omitted to facilitate easy understanding of the structure of the press holder.

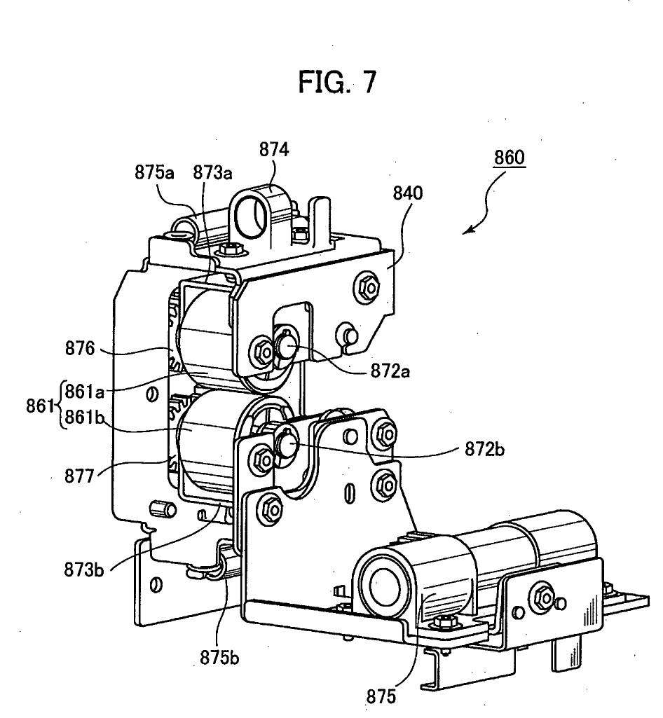

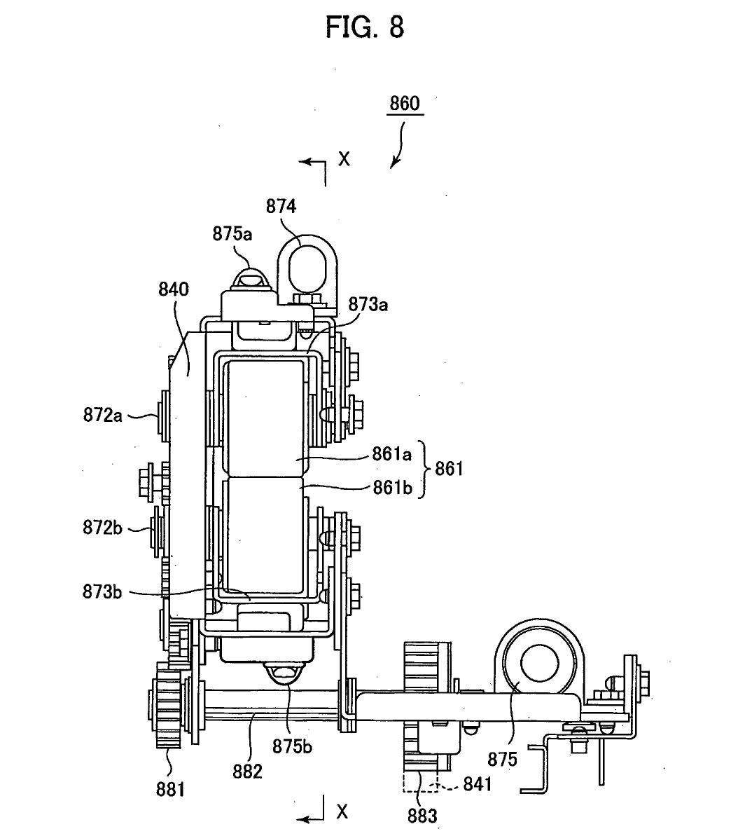

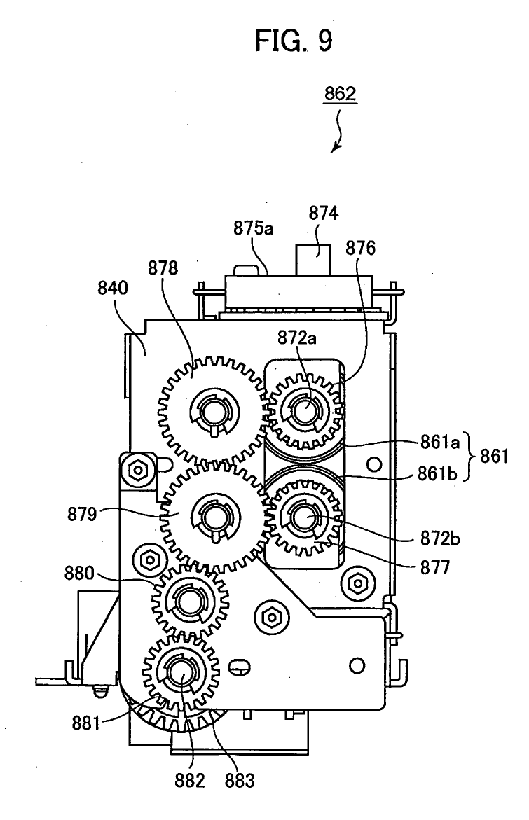

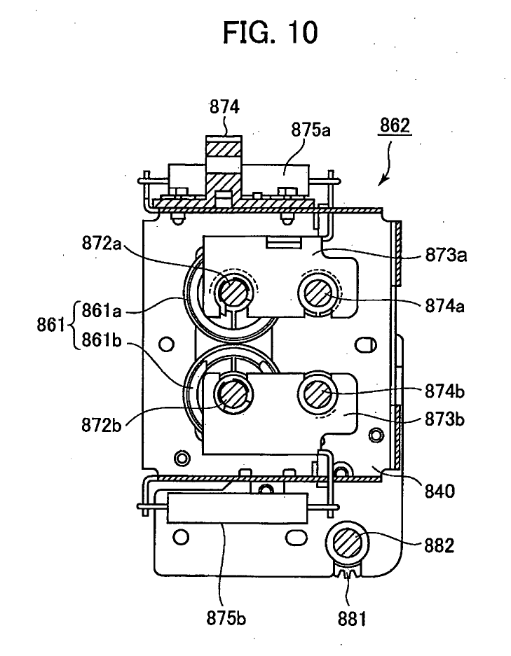

FIG. 7 is an outline perspective view of the press holder 862, FIG. 8 is a front view of the press holder 862, FIG. 9 is a view along arrow B in FIG. 1, and FIG. 10 is a cross-sectional view taken along an arrow X-X in FIG. 8.

The press holder 862 has a frame 840. On the frame 840, the slide bearings 874 and 875 are, respectively, fixed by screws. Press roller pair 861a and 861b are firmly fixed on roller axes 872a and 872b, respectively, and via a bearing (not illustrated). The press roller pair are rotatably supported by press arms 873a and 873b. In addition, the press arms 873a and 873b (FIG. 10) are supported by swinging axes 874a and 874b fixed on the frame 840 via bearings.

Tension springs 875a and 875b are mounted so as to lie between end portions of the press arms 873a and 873b and the frame 840. The press roller pair 861a and 861b is pulled by the tension springs 875a and 875b in a direction such that the press rollers 861a and 861b approach each other so as to form a nip. However, when the sheet bundle enters the press roller pair 861a and 861b, the press arms 873a and 873b are rotated about the swinging axes 874a and 874b which serve as fulcrum points, so that a gap is generated between the press roller pair 861a and 861b.

Certain end portions of the roller shafts 872a and 872b protrude out of the frame 840 toward the outside so that gears 876 and 877 can be fixedly mounted thereon. In addition, at the frame 840, gears 880, 879, and 878 are rotatably supported. More specifically, the gear 878 is engaged with a gear 876, the gear 879 with a gear 877, and the gear 880 with a gear 881. The gear 881 is fixedly mounted on a gear shaft 882.

The gear shaft 882 is rotatably supported by the frame 840 via the bearings. On the other end of the gear shaft 882 (FIG. 8), a gear 883 is fixedly mounted. When this gear 883 is rotated, the press roller pair 861a and 861b are rotated, respectively, by rotating forces transmitted via the gear train. The directions of rotation of the press rollers are the same with respect to the sandwiched sheet bundle. The gear 883 is engaged with a rack gear 841 (FIGS. 3 and 5). The rack gear 841 is extended in parallel with the slide shafts 864 and 865 so as to be fixed to the base plate 863.

Further, when the motor M6 is driven, the timing belt 868 circulates and the press holder 862 is moved while being supported by the slide shafts 864 and 865. In accordance with this movement, the gear 883 of the press holder 862 rotates while being engaged with the rack gear 841. Due to the rotation of the gear 883, the press roller pair 861a and 861b is also rotated. A gear ratio of each gear is set so that the moving velocity of the press holder 862 is identical with the circumferential velocities of the press roller pair 861a and 861b.

When the crease processing is carried out to form the crease on the folded part of the sheet by the press roller pair 861, the internally folded sheet bundle is stopped and held by a plurality of roller pairs at a symmetric position centering around the center part of the conveying direction of the internally folded sheet bundle despite the size of the sheet to be processed. In other words, to the internally folded sheet bundle, the nip pressure F3 of the second folding conveying roller pair 812 is added at its leading end side; the nip pressure F2 of the first folding conveying roller pair 811 is added at its trailing end side; and depending on the size of the internally folded sheet bundle (the length in the conveying direction), the nip pressure F1 of the folding roller pair 810 is also added at the same time. Therefore, when the press roller pair 861 nips the internally folded sheet bundle, even if a rotation moment is generated on the internally folded sheet bundle, each roller pair can apply a pressure to the internally folded sheet bundle so as to prevent the internally folded sheet bundle from being moved against the rotation moment.

Further, with regard to the front end stop position of the saddle sheet bundle (i.e., the press front end position) at the time of implementing the crease processing of the folded part of the front end of the saddle sheet bundle with certainty, it is to be noted that a sensor 884 disposed on a convey guide 814 detects the front end of the saddle sheet bundle so that a relative relation between the press roller pair 861 and the front end of the saddle sheet bundle is made constant despite the size of the bundle.

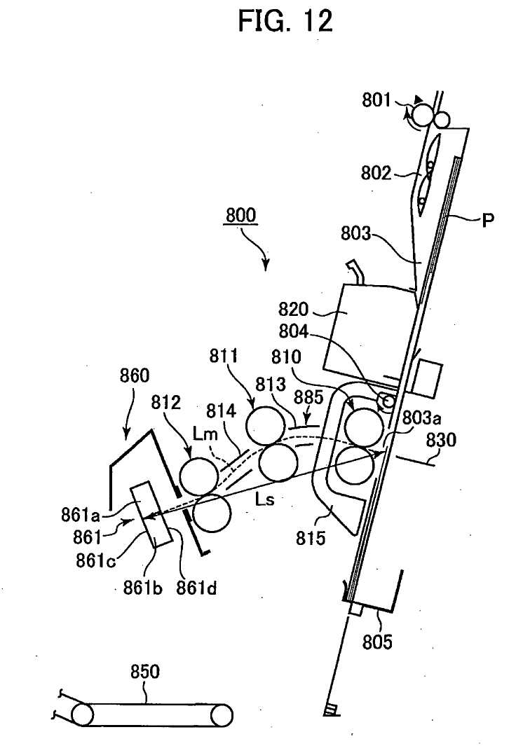

On the other hand, at the rear end position (the press rear end position) upon conducting the crease processing, the alignment of each component is decided so that a rear end Pc of the saddle sheet bundle is prevented from being left in the storage guide 803 while the portion being either opened or being closed. In other words, a direct shortest distance Ls (FIG. 12) of a guide path 885, which extends from an ejection portion 803a where the sheet bundle stored in the storage guide 803 is pushed by the extrusion member 830 so as to be ejected to a downstream side face 861c of the nip of the press roller pair 861, which is provided as the crease processing unit, is preliminarily set to be shorter than the length L1 of the saddle sheet bundle to be creased taken in the conveying direction and when being of its largest size (Ls<L1). Further, the start point of the guide path 885 is located at the ejection portion 803a of the storage guide 803, and the ending point thereof is located at the downstream side face 861c of the press roller pair 861.

The conveying guides 813 and 814 are gently curved so as to prevent curling of the saddle sheet bundle. Then, a distance Lm of the guide path 885 extending from the ejection portion 803a of the storage guide 803 to the downstream side face 861c of the press roller pair 861 via the folding roller pair 810 and the conveying guides 813 and 814 is set to be longer than the conveying direction length L1 of the saddle sheet bundle to be creased when it is of the largest size (Lm>L1).

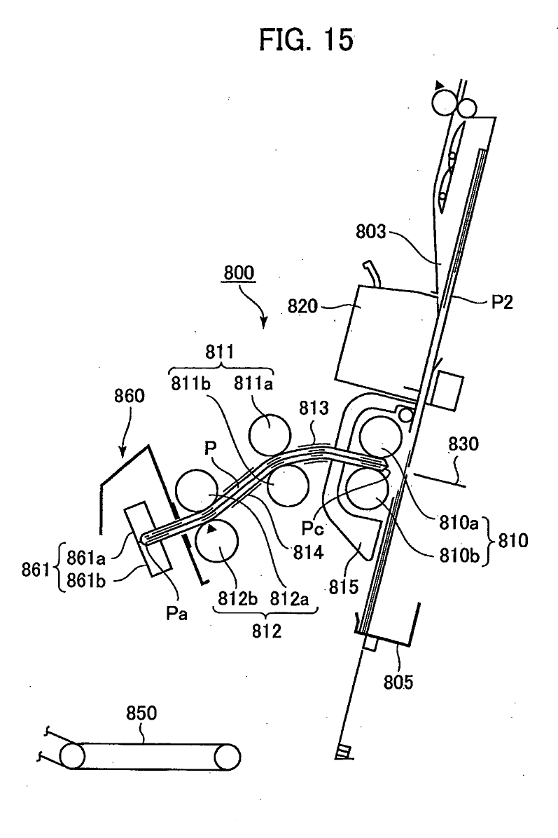

Further, the press roller pair 861 can carry out the crease processing of the sheet bundle by locating the front end position Pa of the sheet bundle at a position about the downstream side face 861c of the nip of the press roller pair 861 (refer to FIG. 15), by locating the front end position Pa of the sheet bundle at a position about the upstream side face 861d of the nip of the press roller pair 861, or by locating the front end position Pa of the sheet bundle at an intermediate position between the above-mentioned two positions. However, the crease processing can be carried out by locating the front end of the sheet bundle at the intermediate position between the downstream side face 861c and the upstream side face 861d of the nip of the press roller pair 861. To this end, the distance between this intermediate position and the ejection portion 803a can be longer than L1, and the direct shortest distance between this intermediate position and the ejection portion 803a can be shorter than L1.

Thus, since the guide path 885 is set to be (Ls<L1) as described above and the conveying guides 813 and 814 are gently curved, the conveying guides 813 and 814 including the press holder 862 are arranged to be accommodated in a spacing between the storage guide 803 (FIG. 1) and the rear end guide 710.

In addition, due to application of the above-mentioned setting (Ls<L1), the saddle stitch binding portion 800 can be located above the folded bundle stacking tray 850 overlapped thereon by using a vertical spacing between the folded sheet bundle stacking tray 850 and the crease pressing unit 860 Accordingly, it is possible to make the horizontal direction of the copy machine shorter.

Further, due to the above setting (Lm>L1), the saddle stitch binding portion 800 does not leave the rear end Pc (FIG. 15) of the saddle sheet bundle P opened within the storage guide 803 during the crease processing by the press roller pair 861 and therefore, does not provide any curl to the rear end portion. As a result, the rear end Pc of the saddle sheet bundle is not left open, thereby improving the sheet bundle. In addition, the saddle stitch binding portion 800 can improve the efficiency of the crease processing of the sheet bundle by making the time interval during which the crease processing of the sheet bundle or the spacing between the preceding and the following sheet bundles shorter.

In addition, due to the setting (Lm>L1), the saddle stitch binding portion 800 does not leave the rear end Pc within the storage guide 803, and when carrying out the crease processing at the folded part of the saddle sheet bundle, the saddle stitch binding portion 800 can improve the efficiency of the crease processing of the sheet bundle by making the crease processing time shorter.

Next, the inserter 900 provided above the finisher 500 will be described with reference to FIG. 1. The inserter 900 is an apparatus for inserting a sheet (an inert sheet) different from a normal sheet in a head page, the last page, or a halfway page of the sheet (the recording paper) on which an image or images is formed by the printer portion 300. The insert sheets for the head page and the last page are the sheets for book covers.

The inserter 900 is configured so as to feed the sheets set on insert trays 901 and 902 to any of the sample tray 701, the stack tray 700, and the folded bundle stacking tray 850 without passing through the printer portion 300. The inserter 900 sequentially separates the bundles of sheets stacked on the insert trays 901 and 902 for each sheet and feeds it in the conveying path 520 at a desired timing.

FIG. 11 is a block diagram for controlling a copy machine 1000. A CPU circuit portion 150 has therein a CPU (not illustrated). The CPU circuit portion 150 is configured to control a copy feeding control portion 101, an image reader control portion 201, an image signal control portion 202, a printer control portion 301, a folding process control portion 401, a finisher control portion 515, and an external I/F 203, on the basis of a control program stored in a ROM 151 and the setting of the operation portion 1. The copy feeding control portion 101 controls the copy feeding portion 100; the image reader control portion 201 controls the image reader portion 20; the printer control portion 301 controls the printer portion 300; the folding process control portion 401 controls the folding process portion 400; the finisher control portion 515 controls the finisher 500, the saddle stitch binding portion 800, and the inserter 900, respectively. The operation portion 1 has a plurality of keys for setting various functions with respect to the image formation and a display portion for displaying the state of setting and so on, outputs a key signal corresponding to the operation of each key by the user to the CPU circuit portion 150, and displays the information corresponding to the signal from the CPU circuit portion 150 on the display portion.

A RAM 152 is used as an area for temporarily holding the control data and a working area of a calculation in association with the controlling operation. The external I/F 203 is an interface between the copy machine 1000 and an external computer 204. The external I/F 203 expands the print data from the computer 204 into a bit map image and outputs it to the image signal control portion 202 as image data. In addition, the image of the copy read by an image sensor (not illustrated) is outputted from the image reader control portion 201 to the image signal control portion 202. The printer control portion 301 outputs the image data from the image signal control portion 202 to an exposure control portion (not illustrated).

Next, a description of the operation of the saddle stitch binding portion 800 will be provided herein below.

When a saddle stitch binding mode is set by the user, the sheets P on which the images are formed are ejected from the ejection roller 118 of the printer portion 300 (FIG. 2). The sheets P pass through the folding process portion 400 to the inlet roller pair 501 (FIG. 1), and then, the sheets P are fed in the lower paper ejection path 622 through the conveying path 520. The sheets are switched to the right side by the switching flapper 514 disposed in the middle of the lower paper ejection path 622 to be fed to the saddle stitch binding portion 800 passing through the saddle paper ejection path 523.

As shown in FIG. 12, the sheets pass to the saddle inlet roller pair 801, the carry-in port is selected by the flapper 802 to be operated by the solenoid according to the size, and the sheets are carried in the storage guide 803 of the saddle stitch binding portion 800. The sheets are struck by the sheet positioning member 805 that stops at a position based on the sheet size in advance of receiving the conveying force of the slip roller 804, and as a result, positioning of the sheets in the conveying direction thereof is achieved.

Subsequently, the sheets are aligned by the aligning plate pair 815 that is arranged at a position having no obstacle against the sheet feeding when the sheets are fed into the storage guide 803 while being sandwiched by the aligning plate pair 815, and then, the opposite side ends of the sheets are aligned. As a result, the lower end and the opposite side ends of the sheets are aligned.

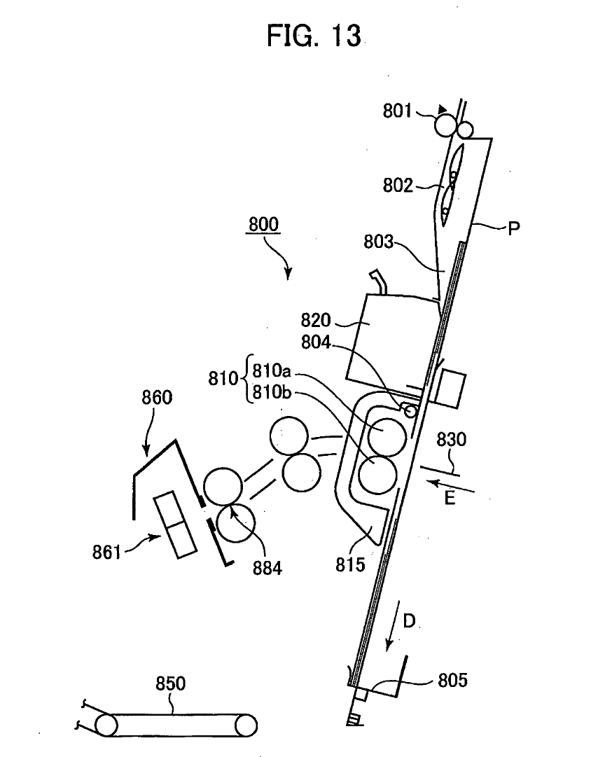

The following sheet storage and the alignment operation are carried out every time the sheets P are fed in the storage guide 803. When the last alignment of the sheet is terminated, the stapler 820 staples the center part of the conveying direction of the sheet bundle stored in the storage guide 803 by a needle. As shown in FIG. 13, the stitched bundle moves downward (an arrow D direction) in accordance with falling of the sheet positioning member 805. The sheet positioning member 805 stops at the position where the center portion of the sheet bundle, namely, a stitching portion of the sheets is opposed to the nip of the folding roller pair 810.

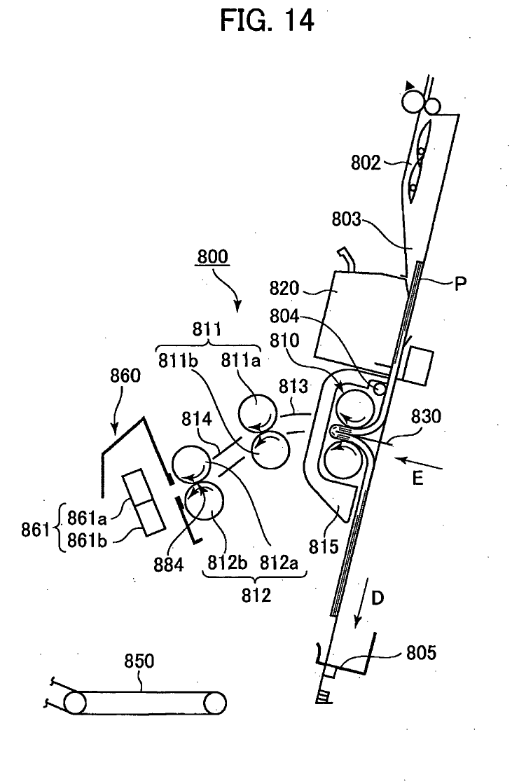

Next, the extrusion member 830 located at the staying position starts to move to the nip of the folding roller pair 810 (to an arrow E direction) to push the center part of the sheet bundle P into the nip of the folding roller pair 810 while expanding the folding roller pair 810. The folding roller pair 810 sandwiches the sheet bundle P by the nip to convey it during rotation thereof, and folds down the sheet bundle into two (FIG. 14). In this case, in addition to the folding roller pair 810, the first folding conveying roller pair 811 and the second folding conveying roller pair 812 are also rotated in the respective direction of arrows upon being driven by the motor M4 (FIG. 1). These roller pairs 810, 811, and 812 convey the internally folded sheet bundle with the folded part of the folded sheet bundle (the internally folded sheet bundle) P as a head. Then, the internally folded sheet bundle is conveyed through the conveying guides 813 and 814.

Then, as shown in FIG. 15, when the internally folded sheet bundle P is conveyed to the position where it is nipped by the press roller pair 861, the folded part Pa is detected by the sensor 884 and the motor M4 is stopped. As a result, the conveying operation is stopped. In this case, the internally folded sheet bundle P is held by the second folding conveying roller pair 812 at its leading end portion (the folded part) and is held by the first folding conveying roller pair 811 at its trailing end side. Further, depending on the size of the internally folded sheet bundle (the length in the conveying direction), the internally folded sheet bundle P is held by the folding roller pair 810. The holding of the internally folded sheet bundle P by the respective conveying roller pairs 812, 811 and 810 is performed at symmetrical positions with the center located at the central position of the sheet bundle in the direction of conveying. At this stage, when the extrusion member 830 completes its extruding operation of the bundle of the sheets, it again returns to the retracted position thereof.

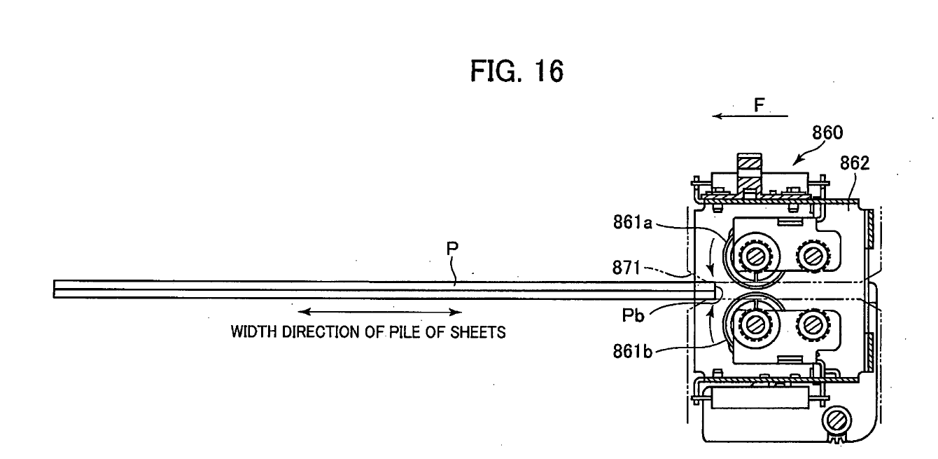

In addition, as shown in FIG. 16, prior to conveying the internally folded sheet bundle P by respective roller pairs 812, 811, and 810, the press holder 862 stays at the stay position thereof (the innermost side) corresponding to the size (that in the width direction) of the internally folded sheet bundle P. When the internally folded sheet bundle P completely stops, and when the folded part of the internally folded sheet bundle P is inserted into the sheet guide 871 (shown by a chained line), the motor M6 starts its operation so that the crease pressing unit 860 starts to move toward this side (i.e., in a direction shown by an arrow F, namely, in the width direction of the internally folded sheet bundle) while rotating the press roller pair 861.

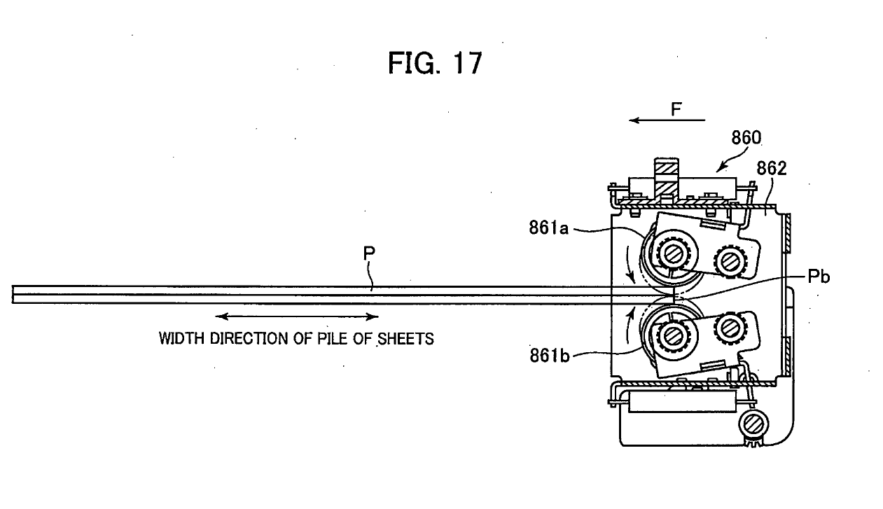

After that, the press roller pair 861 abuts against a side end portion Pb of the internally folded sheet bundle P in the sheet conveying direction that is stopped and held there. The press roller pair 861a and 861b rotates together, and they permit the side end portion of the sheet bundle P to enter therebetween and smoothly run on that side end portion Pb so as to sandwich the folded part (refer to FIG. 17). The press roller pair 861 is configured so that the pair can constantly nip the internally folded sheet bundle without any change in its nipping state irrespective of any increase in the thickness of the internally folded sheet bundle, while being synchronized with the movement of the press holder 862 without causing any delay of response. Therefore, the press roller pair 861 can certainly form a crease on the folded portion of the internally folded sheet bundle P without applying any damage to the internally folded sheet bundle P that might be caused by tearing of the internally folded sheet bundle P, generation of a wrinkle on the internally folded sheet bundle P, and providing the trail of the rollers thereon.

In addition, since the press roller pair 861 runs on the side end portion Pb of the internally folded sheet bundle P so as to push the internally folded sheet bundle P, the rotation moment is generated which acts on the internally folded sheet bundle P. However, as described above, since the internally folded sheet bundle P is surely sandwiched between the first folding conveying roller pair 811 and between the second folding conveying roller pair 812 that are used as holding portions arranged at positions separated at a long span (the roller pair 810 may also sandwich the internally folded sheet bundle P depending on the sheet size), the internally folded sheet bundle P can resist the rotation moment, and the sheet bundle P is hardly declined and misaligned.

For such reason, the press roller pair 861 does not damage the internally folded sheet bundle P due to tearing of the internally folded sheet bundle P, generation of a wrinkle on the internally folded sheet bundle P, and providing of the trail of the rollers thereon. Further, the press roller pair 861 can smoothly rotate and run so as to form a crease on the folded part.

Further, the first folding conveying roller pair 811 and the second folding conveying roller pair 812 are aligned in a direction along the sheet conveying direction. However, they may be aligned lined up on a direction intersecting with the sheet conveying direction (the width direction of the sheet). In other words, the first folding conveying roller pair 811 and the second folding conveying roller pair 812 may be arranged at a position where the torque is not generated at the sheet bundle to sandwich (hold) the sheet bundle.

In addition, depending on the length of the internally folded sheet bundle, the number of the roller pairs equivalent to the first folding conveying roller pair 811 and the second folding conveying roller pair 812 may be increased. Further, any one roller pair among the first and second folding conveying roller pairs 811 and 812 and the folding roller pair 810 may be sufficient.

Alternatively, respective roller pairs 812, 811, and 810 can be a belt pair.

Further, the first and second folding conveying roller pairs 811 and 812 are configured with a conveying function to convey the internally folded sheet bundle and a holding function to hold the internally folded sheet bundle so as to prevent the sheet bundle from being misaligned. Alternatively, the roller pairs 811 and 812 may be provided with only the conveying function with the holding function replaced by the other holding mechanism. This holding mechanism sandwiches the internally folded sheet bundle from both sides thereof by a pair of holding elements to be opened and closed by a plunger (not illustrated) when the press roller pairs 861a and 862b are aligning the shape of the folded part of the internally folded sheet bundle.

In addition, since the press holder 862 and the press rollers 861a and 861b are driven by the motor M6 as one driving source, as compared to the case that a plurality of motors is used, the press holder 862 and the press rollers 861a and 861b can adjusted to each velocity with a simple structure.

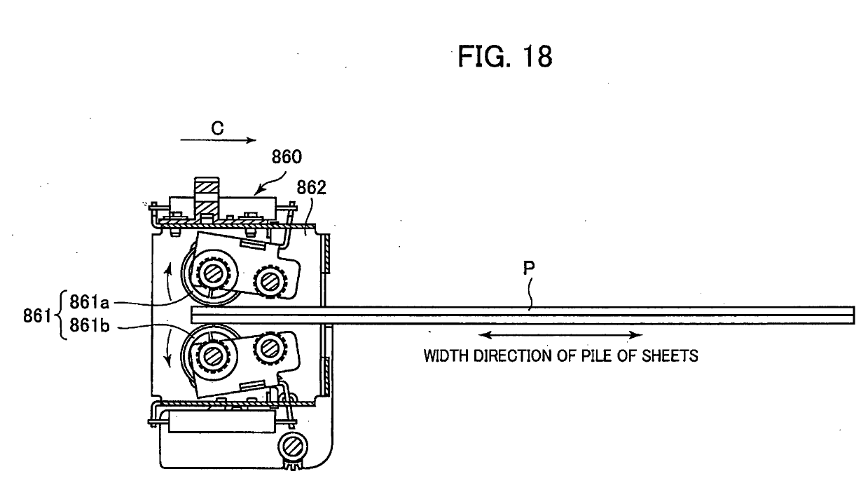

The press roller pair 861 running on the folded part continues to move while pressing the folded part, stops at the front position of the internally folded sheet bundle P (FIG. 18), and returns to the back side (the arrow C direction). A crease is certainly made on the folded part due to the back-and-forth operation of the press roller pair 861. The number of reciprocation of the press roller pair 861 can be changed depending on the size, the number, the thickness, and the image information (the toner amount attached to the sheet) of the sheet. In other words, by increasing the number of reciprocation with respect to the sheet on which a crease is hardly made, it is possible to certainly make the crease on the folded part. The number of reciprocation can be set on the basis of experimental result.

As described above, during the crease processing of the folded part by the press roller pair 861, the rear end Pc of the internally folded sheet bundle P is located outside the area of the storage guide 803 as shown in FIG. 15. Accordingly, if the following sheet bundle P2 to be subsequently processed is located, the printer portion 300 can continue the image formation without stopping and can store and align the sheets in parallel with the crease processing of the previous internally folded sheet bundle. In addition, the rear end Pc stopping during the crease processing operation is overlapped and stored in the conveying guide 813 without opening, so that curl to separate them each from other is not applied.

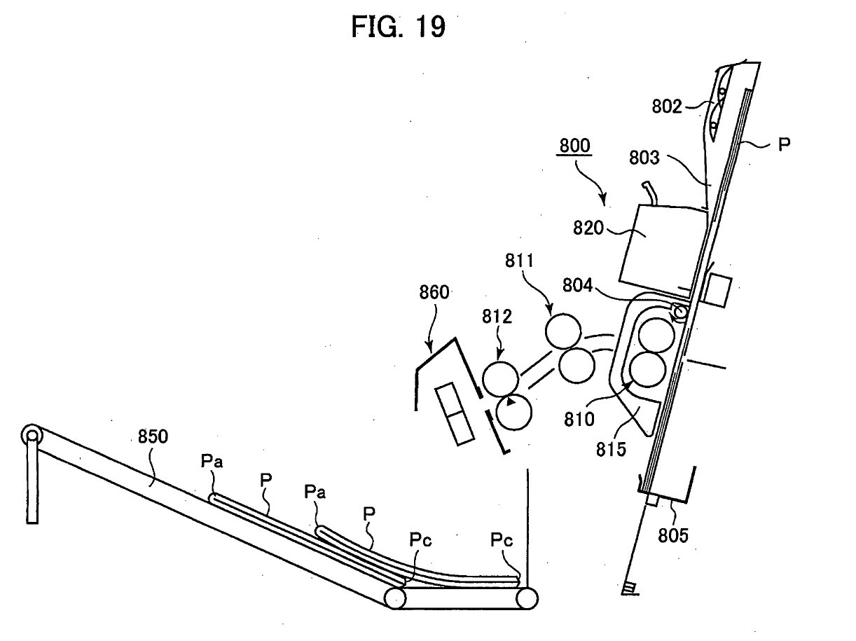

After a predetermined number of reciprocatory motions of the press roller pair 861, the press holder 862 moves to the home position thereof and releases the path in the conveying direction of the internally sheet bundle. Consequently, as shown in FIG. 19, respective roller pairs 810, 811, and 812 having stopped are rotated by the motor M4, and accordingly, the conveying of the internal sheet bundle is restarted so as to be discharged onto the folded bundle stacking tray 850. The discharged internally folded sheet bundle P is stacked on the folded bundle stacking tray 850 with the crease Pa certainly folded and the rear end Pc closed due to the above-described operations.

By repeating the above-described operations, the saddle stitch binding portion 800 can stack the desired number of sheet bundles on the folded bundle stacking tray 850. A folding characteristic of each of internal sheet bundle can be improved due to the above-described crease processing, so that each of internal sheet bundle is stacked on the folded bundle stacking tray 850 with a quality of alignment on the folded bundle stacking tray 850 also improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Laid-Open No. 2005-171718, filed Jun. 10, 2005, which is hereby incorporated by reference herein in its entirety.

What is claimed is:

1. A sheet processing apparatus, comprising:
a folding unit configured to fold a sheet bundle;
a crease processing unit forming a crease on a folded part of the sheet bundle; and
a plurality of holding portions each holding the sheet bundle between the folding unit and the crease processing unit, as the crease processing unit forms the crease on the folded part of the sheet bundle

2. The sheet processing apparatus according to claim 1, wherein the holding portion holds the sheet bundle at symmetric positions with respect to a central portion of the sheet bundle in a conveying direction, as the crease processing unit is forming a crease on the sheet bundle.

3. The sheet processing apparatus according to claim 1, wherein the holding portion includes a conveying portion configured to convey the sheet bundle.

4. The sheet processing apparatus according to claim 1, wherein the holding portion includes a roller pair holding the sheet bundle by sandwiching the sheet bundle.

5. A sheet processing apparatus, comprising:
a folding unit configured to hold and fold a sheet bundle while conveying the sheet bundle;
a crease processing unit forming a crease on a folded part of the sheet bundle; and
a holding portion holding the sheet bundle between the folding unit and the crease processing unit,
wherein the folding unit and the holding portion hold the sheet bundle when the crease processing unit is forming the crease on the folded part of the sheet bundle.

6. The sheet processing apparatus according to claim 5, wherein the holding portion and the folding unit hold the sheet bundle at symmetric positions with respect to a central portion of the sheet bundle in a conveying direction when the crease processing unit is forming a crease on the sheet bundle.

7. The sheet processing apparatus according to claim 5, wherein the holding portion includes a conveying portion configured to convey the sheet bundle.

8. The sheet processing apparatus according to claim 5, wherein the holding portion includes a roller pair holding the sheet bundle by sandwiching the sheet bundle.

9. An image forming apparatus, comprising:
an image forming portion configured to form an image on a sheet; and
the sheet processing apparatus, which carries out a crease processing on a folded part of a sheet bundle on which the image is formed by the image forming portion, according to claim 1.

10. The image forming apparatus according to claim 9, wherein the plurality of the holding portions holds the sheet bundle at symmetric positions with a center located at a central portion of the sheet bundle in a conveying direction when the crease processing unit is forming a crease on the sheet bundle.

11. An image forming apparatus, comprising:
an image forming portion configured to form an image on a sheet; and
the sheet processing apparatus, which carries out a crease processing on a folded part of a sheet bundle on which the image is formed by the image forming portion, according to claim 5.

12. The image forming apparatus according to claim 11, wherein the holding portion holds the sheet bundle at symmetric positions with respect to a central portion of the sheet bundle in the conveying direction when the crease processing unit is forming the crease on the sheet bundle.
